(19) United States
(12) Patent Application Publication
(10) Pub. No.: US 2018/0096434 A1
(43) Pub. Date: Apr. 5, 2018

(54) System and Method for Controlling Access to Content to be Displayed on an Electronic Display

(71) Applicant: The Toronto-Dominion Bank, Toronto (CA)

(72) Inventors: Garima AGGARWAL, Toronto (CA); Hisham Ibrahim SALAMA, Toronto (CA); Rakesh Thomas JETHWA, Toronto (CA); Paul Mon-Wah CHAN, Markham (CA); John Jong Suk LEE, Toronto (CA); Dean C. N. TSERETOPOULOS, Toronto (CA); Amber Rose COSSITT, Courtice (CA)

(21) Appl. No.: 15/286,345

(22) Filed: Oct. 5, 2016

(51) Int. Cl. G06Q 40/00

(52) U.S. Cl. CPC G06Q 40/12

(57) ABSTRACT

A method and system are provided for displaying content on an electronic display. The method includes receiving data representing a plurality of items, each of the plurality of items being associated with a product or service. The method also includes requesting and receiving financial health data associated with a purchasing entity. The method also includes determining a subset of items from the plurality of items based on affordability relative to the financial health data, and having at least one of the plurality of items displayed on the electronic display. The subset of items may be displayed in a different manner than the other plurality of items displayed, the different manner may include either or both reducing visibility of the subset of items, and excluding the subset of items from being displayed.

### TECHNICAL FIELD

The following relates generally to controlling access to content to be displayed on an electronic display.

### BACKGROUND

Electronic payment systems enable a consumer to pay for products and services without accessing, handling, or sending physical currency or physical instruments representing funds. For example, payment terminals, also known as point of sale terminals, allow for a consumer to swipe, insert or tap a credit card or debit card to provide a payment to a merchant. In recent years, payments can be made using mobile devices. For example, a payment can be made via the internet by using a mobile device to access mobile applications (e.g., banking applications, merchant applications), merchant websites, digital wallets, etc. A mobile device may also communicate with a point of sale terminal to make a payment using short-range wireless communication technology (e.g., near field communication or radio-frequency identification). However, the availability and convenience of electronic payment systems can increase consumer spending in a way that may conflict with a consumer's ability to budget and/or accumulate savings.

### BRIEF DESCRIPTION OF THE DRAWINGS

Embodiments will now be described by way of example only with reference to the appended drawings wherein:

FIG. 1 is a schematic diagram of an example computing environment.

FIG. 2 is a block diagram of example data components of a data storage.

FIG. 3 is a block diagram of an example computing system.

FIG. 4 is a block diagram of an example configuration of an application plug-in module.

FIGS. 5A-5D are schematic diagrams of example computing environments configured to modify page data to be displayed on a display of a client device.

FIG. 6 is a flow diagram of an example of computer executable instructions for modifying page data to be displayed for a requested merchant page.

FIG. 7 is a flow diagram of an example of computer executable instructions for generating modified page data by comparing financial health data to parameters associated with items to determine affordability of items to a purchasing entity.

FIG. 8 is an example of a graphical user interface of a browser application displaying a list of items provided by a merchant website.

FIG. 9 is an example of a graphical user interface of a browser application displaying a list of items provided by a merchant website with items removed by an application plug-in module.

FIG. 10 is an example of a graphical user interface of a browser application displaying a list of items provided by a merchant website with items obfuscated by an application plug-in module.

FIG. 11 is an example of a graphical user interface of a browser application displaying a list of items provided by a merchant website with items removed and obfuscated by an application plug-in module.

FIG. 12 is a flow diagram of an example of computer executable instructions for enabling an obfuscation of an item to be overridden by a purchasing entity.

FIGS. 13A-13C is an example of graphical user interfaces of a browser application enabling an obfuscation of an item to be overridden by a purchasing entity.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein. Also, the description is not to be considered as limiting the scope of the example embodiments described herein.

Electronic payment systems, particularly those provided through online applications and websites can facilitate the searching and locating of products and services as well as the spending of funds by making the payment process shorter and more convenient for a consumer. This can facilitate impulse purchases by minimizing the time between a consumer's initial decision to make an impulse purchase and completion of the purchase (i.e. by providing payment), during which time the consumer may otherwise reconsider the purchase. Impulse or otherwise unwise purchases may also be facilitated by the media content displayed in association with the merchandise. This media content may not only make the consumer become aware of these potentially unaffordable products and/or services, but also the manner in which these products and services are displayed and advertised may be in an appealing and desirable manner to the consumer regardless of their affordability to that consumer.

Avoiding or limiting access to items displayed on an electronic device, which are associated with products and services that are determined to be unaffordable to a consumer or other purchasing entity relative to financial health data; may deter or minimize the desire to purchase those products or services. When a purchasing entity is deterred or prevented from accessing and purchasing certain items, or is unaware of the availability of such items altogether, obstacles to maintaining a budget or accumulating savings may be avoided.

In one aspect, there is provided a computing device for displaying content on an electronic display, the device comprising a processor coupled to a memory, a communications module, and the electronic display, the memory storing computer executable instructions that when executed by the processor cause the processor to: receive via the communications module data representing a plurality of items, each of the plurality of items being associated with a product or service; request and receive via the communications module financial health data associated with a purchasing entity; determine a subset of items from the plurality of items based on affordability relative to the financial health data; and display at least one of the plurality of items on the electronic display.

In another aspect, there is provided a method of displaying content on an electronic display, comprising: receiving data representing a plurality of items, each of the plurality of items being associated with a product or service; requesting and receiving financial health data associated with a purchasing entity; determining a subset of items from the plurality of items based on affordability relative to the financial health data; and having at least one of the plurality of items displayed on the electronic display.

In another aspect, there is provided a non-transitory computer readable medium for displaying content on an electronic display, the computer readable medium comprising computer executable instructions for: receiving data representing a plurality of items, each of the plurality of items being associated with a product or service; requesting and receiving financial health data associated with a purchasing entity; determining a subset of items from the plurality of items based on affordability relative to the financial health data; and having at least one of the plurality of items displayed on the electronic display.

In certain example embodiments, a plug-in module may be used as a screen modifier or interrupter that determines a purchasing entity is accessing an e-commerce website or using an application with e-commerce capabilities and removes or obfuscates (i.e. reduces visibility of) a subset of items that would otherwise be displayed, based on affordability of those items relative to a financial health of the purchasing entity.

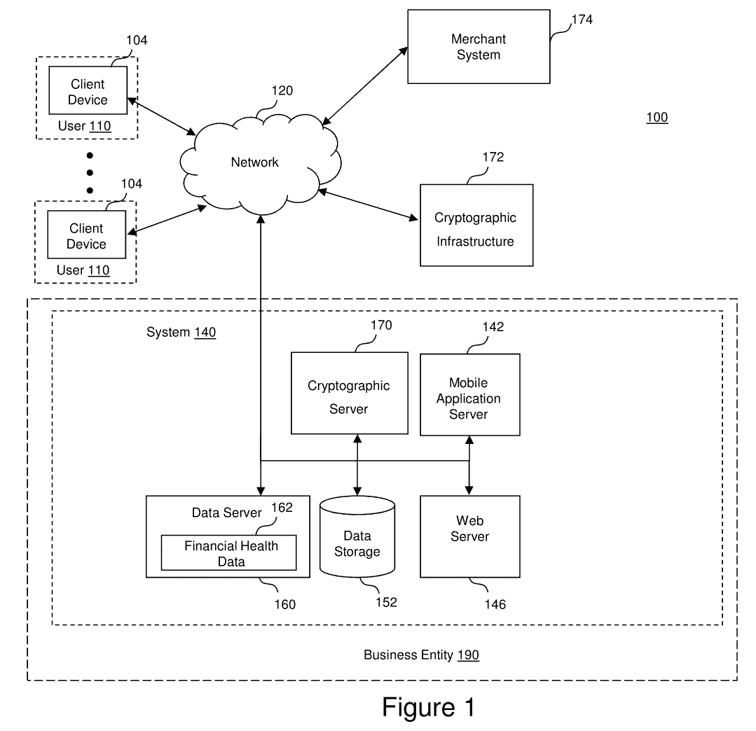

FIG. 1 illustrates an exemplary computing environment 100. In one aspect, the computing environment 100 may include one or more client devices 104, a system 140 associated with a business entity 190, a cryptographic infrastructure 172, a merchant system 174, and a communication network 120 connecting one or more of the components of the computing environment 100.

In certain example embodiments, client devices 104 may be one or more computer systems configured to process and store information and execute software instructions to perform one or more processes consistent with the disclosed embodiments. Client devices 104 may be associated with one or more users 110. Users 110 can include both real and/or virtual/automated entities or organizations (e.g. businesses, corporations, etc.) and these real and/or virtual/automated entities may also be referred to herein as purchasing entities when engaging in a computing session wherein a purchase is being contemplated, researched, executed, etc. The computing environment 100 may include multiple client devices 104, each associated with a separate user 110 or with one or more users 110. In certain embodiments, user 110 may operate client device 104 such that client device 104 performs one or more processes consistent with the disclosed embodiments. For example, a consumer or user 110 may use client device 104 to browse sites associated with merchant systems 174 via e-commerce websites or within applications (commonly referred to as “apps”), and perform transactions involving one or more accounts associated with user 110 and/or other users that are provided, maintained, managed, and/or processed by system 140. In certain example embodiments, client device 104 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a point of sale terminal, computing systems of a merchant, and any additional or alternate computing device, and may be operable to transmit and receive data across communication network 120.

Communication network 120 may include a telephone network, cellular, and/or data communication network to connect different types of client devices 104. For example, the communication network 120 may include a private or public switched telephone network (PSTN), mobile network (e.g., code division multiple access (CDMA) network, global system for mobile communications (GSM) network, and/or any 3G or 4G wireless carrier network, etc.), WiFi or other similar wireless network, and a private and/or public wide area network (e.g., the Internet).

In certain example embodiments, system 140 may be one or more computer systems configured to process and store information and execute software instructions to perform one or more processes consistent with the disclosed embodiments. In certain embodiments, although not required, system 140 may be associated with one or more business entities, such as business entity 190. In certain embodiments, business entity 190 may be any type of business entity. For example, system 140 may be a system associated with a commercial bank or other financial institution, a retailer, or some other type of business.

While certain aspects of the disclosed embodiments are described in connection with business entity 190 as a financial institution (e.g., commercial bank) that provides financial services accounts to users 110 and processes financial transactions associated with those financial service accounts, the disclosed embodiments are not so limited. In other embodiments, system 140 may be associated with a business entity 190 that provides customer or user accounts, such as retailers, merchants and other consumer and/or commercial service providers.

In the configuration for the computing environment 100 shown in FIG. 1, the merchant system 174 represents an entity with which the client device 104 interacts to browse, review and potentially obtain a product or service, e.g., via an online web page or application; whereas the business entity 190 represents another entity that is in possession of financial health data 162 associated with a purchasing entity such as the user 110. The business entity 190 can be a financial institution or another type of entity as indicated above. It can also be appreciated that both the merchant system 174 and business entity 190 can be financial institutions, e.g., where one financial product or service offered by one financial institution is being browsed for potential purchase, while the financial health data 162 for the purchasing entity is determinable from data available to (or created by) another financial institution such as one providing personal banking and/or credit products.

The system 140 may include one or more servers to facilitate or carry out a service requested by user 110 via the client device 104. Exemplary servers include a mobile application server 142, a web server 146 and a data server 150. The system 140 may also include a cryptographic server 170 for performing cryptographic operations and providing cryptographic services. The cryptographic server 170 can also be configured to communicate and operate with a cryptographic infrastructure 172. The system 140 may also include one or more data storages for storing and providing data for use in such services, such as data storage 152.

Mobile application server 142 supports interactions with a mobile application installed on client device 104. Mobile application server 142 can access other resources of system 140 to carry out requests made by, and to provide content and data to, a mobile application on client device 104. In certain example embodiments, mobile application server 142 supports a mobile banking application to provide payments from one or more accounts of user 110.

Web server 146 supports interactions using a website accessed by an internet browser running on the client device 104. For example, a user 110 may access a merchant's webpage to purchase products and services online. In another example, the web server 146 may support a digital wallet provider in which user 110 can arrange for payment from one or more accounts registered with the digital wallet provider.

In certain example embodiments, either or both mobile application server 142 and web server 146 can access resources of system 140 to carry out requests made by, and provide content and data to, the purchasing entity such as client device 104 or merchant system 174, e.g., to provide financial health data 162 associated with a purchasing entity interacting with the merchant system 174.

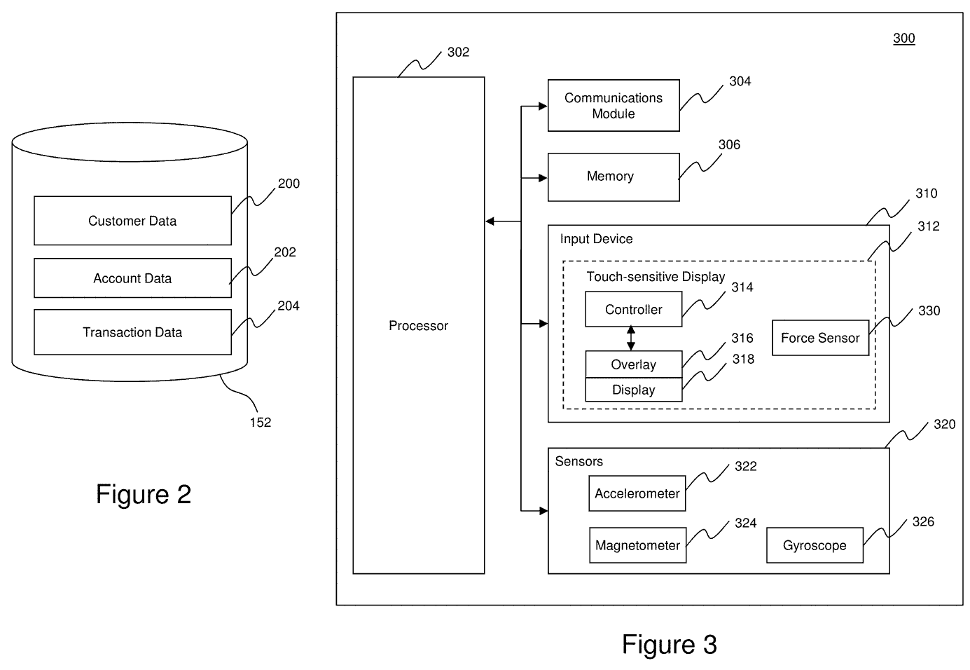

Data storage 152 may include one or more data storage devices configured to store information consistent with the disclosed embodiments. In an example embodiment shown in FIG. 2, data storage 152 may include customer data 200, account data 202, and transaction data 204. In one aspect, customer data 200 may include one or more data records uniquely identifying one or more users 110 of business entity 190 associated with system 140. By way of example, a customer of a financial institution (e.g., business entity 190) may access a web page associated with system 140 (e.g., through web server 146), and subsequently register for online banking services and provide data. The data may be linked to the customer and stored within customer data 200.

In certain example embodiments, customer data 200 may include personal information associated with a user 110 (e.g., a name, home address, or date of birth), demographic information (e.g., educational level, income level), government-issued identifiers (e.g., driver's license numbers or Social Security numbers), employment information (e.g., employer name or address), and/or contact information (e.g., e-mail addresses, home numbers, work numbers, or mobile numbers). Other types of customer information may be stored and used.

Customer data 200 may include client device identification information identifying one or more client devices 104 registered to user 110. In one embodiment, the user may provide the client device identification information (e.g., a mobile telephone number provided by the user when registering for online banking services). Alternatively, system 140 may be configured to execute processes that automatically collect client device identification information (e.g., collecting an Internet Protocol (IP) address associated with the customer's smartphone by web server 146).

In certain example embodiments, customer data 200 may include geographic position data associated with user 110 and/or at least one of the client devices 104 registered to user 110. For instance, the geographic position data may identify a current geographic position of user 110 and/or the client devices 104, and additionally or alternatively, one or more prior geographic positions of user 110 and/or the client devices 104. In certain example embodiments, system 140 may obtain a portion of the geographic position data from client device 104 across communication network 120. By way of example, client device 104 may include a global position system (e.g., a GPS) that tracks a current geographic position of client device 104, and client device 104 may transmit geographic position data indicative of the current geographic position of client device 104 to system 140 across communication network 120. For instance, client device 104 may append the geographic position data to data transmitted to system 140 in response to a completed transaction, and/or a required update to system 140. In other instances, client device 104 may transmit the geographic position data to a third-party system (e.g., a mobile telecommunications provider), and system 140 may obtain portions of the geographic position data from the third-party system across network 140 through an appropriate application programming interface (API). Upon receipt of the geographic position data from client device 104 and/or the third-party system, system 140 may be configured to format and store the received positional information within data storage 152 (e.g., as portions of customer data 200).

In certain example embodiments, customer data 200 may include user (i.e. purchasing entity) preference data. The preference data may be stored such that the preference data may be associated with a product or service preferred by the purchasing entity based on the purchasing entity preference data, that is what is noted as being preferential to the purchasing entity. This preference data can be associated with the subset of items that is obfuscated (i.e., visibility reduced) or eliminated/blocked from what is displayed to the purchasing entity as described herein. The purchasing entity preference data may include a product or service identified in a previous transaction of the purchasing entity.

In certain example embodiments, account data 202 may include information identifying one or more accounts of customers of a financial institution (e.g., business entity 190) associated with system 140. In one embodiment, account identification information may include financial service account information. For example, such service account information may include a chequing account, a savings account, a revolving credit line, an account linked to a credit or debit card, a brokerage account, a wealth account, an investment account, mortgage product and any additional or alternate account provided or supported by the issuing bank. In other embodiments, account data 202 may include information identifying investment portfolios held by one or more customers of the financial institution (e.g., positions in one or more securities held by the customers). Information within account data 202 may also identify, for a single customer, one or more accounts associated with the customer and account data corresponding to the accounts (e.g., account, expiration date information, and/or card security codes, account balance information, and/or credit limit information).

In other aspects, account data 202 may include account information associated with nonfinancial service accounts, such as online customer or loyalty program accounts for retailers, merchants or other services or activities.

Transaction data 204 may include information identifying one or more transactions involving one or more customers or accounts of business entity 190 associated with system 140. In one embodiment, such transactions may include, but are not limited to, purchase transactions (e.g., purchases of products and/or services from electronic or physical retailers), financial service transactions (e.g., fund transfers), bill payment transactions (e.g., electronic bill payment transactions), financial instrument or security transactions (e.g., purchases of securities), deposits or withdrawals of funds, or applications for credit from the financial institution or other entity.

Referring back to FIG. 1, data server 160 stores financial health data 162 and provides access to such data to other servers within system 140, and/or other computer systems (e.g., client device 104) outside of system 140 across network 120 through corresponding APIs. Financial health data 162 may include parameters indicative of the financial health of one or more users 110 of business entity 190 associated with system 140. For the sake of simplicity, three different levels or thresholds of financial health may be considered in some of the disclosed embodiment herein, labelled as WEAK, ACCEPTABLE and STRONG. It will be appreciated that additional levels or thresholds of financial health may be determined and used in the disclosed embodiments, and such labels can represent ratios, numbers and other values and quantifications of financial health generated from any suitable means. The disclosed embodiments herein can apply to any suitable means of evaluating and quantifying financial health and various metrics and parameters may be used.

In certain example embodiments, financial health data 162 may include various ratios of financial data used to evaluate personal financial health (e.g., debt/expenses to income ratios). Financial health data 162 may also compare such ratios against predetermined ratio thresholds associated with different levels or thresholds of financial health of user 110. For example, financial health data 162 may include a monthly debt (e.g., mortgage, loans, credit lines, credit cards, etc.) to gross income ratio, and use a value of 36% as the threshold indicative of ACCEPTABLE financial health. Ratios above 36% can be attributed to WEAK financial health (increasingly weaker as the ratio increases) and below 30% to STRONG financial health (increasingly stronger as the ratio decreases).

In another example, financial health data 162 may include data indicative of whether total monthly expenses exceed net income for user 110. Financial health may be determined by associating a different level of financial health to different amounts (or ranges thereof) of deficient or excess income relative to expenses.

In certain example embodiments, financial health data 162 may include data indicative of the amount of savings (e.g., cash and cash equivalents) accumulated in the accounts of user 110, and the number of months of certain expenses (e.g., mortgage/rent, utilities, groceries, gas, and other reoccurring expenses such as property taxes, tuition, etc.) such accumulated amounts can cover. Financial health data 162 may also compare such number of months against predetermined month thresholds associated with different levels of financial health of user 110. Financial health may be determined by associating a different level of financial health to different number of months (or ranges thereof) of deficient or excess savings relative to monthly expenses. In certain example embodiments, financial health data 162 may also include a rate at which the savings of user 110 is increasing or decreasing. Financial health may be determined by associating a different level of financial health to different rates (or ranges thereof) that savings are being depleted or accumulated.

In certain example embodiments, financial health data 162 can include budgeting data of user 110. For example, budgeting data may include monthly saving targets for specific accounts (e.g., savings account, retirement account, etc.) or for specific goals (e.g., purchase of house, vacation, car, etc.) and indicators of whether such saving targets are being met. Financial health may be determined by associating a different level of financial health to different amounts (or ranges thereof) of deficient or excess savings relative to the savings target. Budgeting data may include monthly spending limits for different categories of expenses (e.g., dining out, entertainment, groceries, transportation, travel, home, health etc.) and an indicator of whether such limits are being exceeded. Financial health may be determined by associating a different level of financial health to different amounts (or ranges thereof) of under or over spending relative to the spending limits. In another example, budgeting data may include a savings goal (defined by an amount and a date by which such amount is to be saved), and an indicator of the progress by user 110 in reaching the savings goal. Financial health may be determined by associating a different level of financial health to different levels of progress in reaching the savings goal.

In certain example embodiments, financial health data 162 that includes budgeting data can take into account the timeframe of a particular savings goal and momentum in savings accumulated, to determine the financial health of user 110. For example, the financial health data 162 may include budgeting data indicating that user 110 has set a goal of saving $12,000 within a 1 year period and that after the first month, only $100 has been saved. At the end of the first month, despite not being on track to reach the savings goal (as the average savings so far has only been $100/month rather than the average monthly savings of $1000/month that would be required to meet the savings goal of $12,000 in 1 year), the financial health data 162 may weight this deficiency in savings less relative to other data used to determine financial health of user 110 given that most of the allotted period to achieve the savings has not yet passed (i.e., 11 of 12 months remain). In another example, the financial health data 162 may include budgeting data indicating that user 110 has set a goal of saving $12,000 within a 1 year period and that savings have been accumulated as follows: $0 up to month 6, $1000 in month 7, $2000 in month 8, $3000 in month 9. At the end of month 9, despite not being on track to reach the savings goal when evaluated based on monthly savings (as the average savings so far has only been $667/month rather than the average monthly savings of $1000/month that would be required to meet the savings goal of $12,000/year), the financial health data 162 may weight this deficiency in savings less in comparison to other data used to determine financial health of user 110 given the momentum/trend in recent months to be saving increasingly larger amounts.

In certain example embodiments, data server 160 generates financial health data 162 from customer data 200, account data 202 and/or transaction data 204 stored in data storage 152. In certain example embodiments, other servers or computing systems that can access data storage 152 may generate and store financial health data 162. For example, in certain example embodiments, client device 110 can access the data storage 152 across network 120 through a corresponding API provided by system 140 to generate financial health data 162 and store such data in memory of the client device 104.

System 140 may also include a cryptographic server 170 for performing cryptographic operations and providing cryptographic services (e.g., authentication (via digital signatures), data protection (via encryption), etc.) to provide a secure interaction channel and interaction session, etc. The cryptographic server 170 can also be configured to communicate and operate with a cryptographic infrastructure 172, such as a public key infrastructure (PKI), certificate authority (CA), certificate revocation service, signing authority, key server, etc. The cryptographic server 170 and cryptographic infrastructure 172 can be used to protect the various data communications described herein, to secure communication channels therefor, authenticate parties, manage digital certificates for such parties, manage keys (e.g., public and private keys in a PKI), and perform other cryptographic operations that are required or desired for particular applications of the system 140. The cryptographic server 170 may be used to protect the customer data 200, account data 202, transaction data 204, and financial health data by way of encryption for data protection, digital signatures or message digests for data integrity, and by using digital certificates to authenticate the identity of the users 110 and client devices 104 with which the system 140 communicates to inhibit data breaches by adversaries. It can be appreciated that various cryptographic mechanisms and protocols can be chosen and implemented to suit the constraints and requirements of the particular deployment of the system 140 as is known in the art.

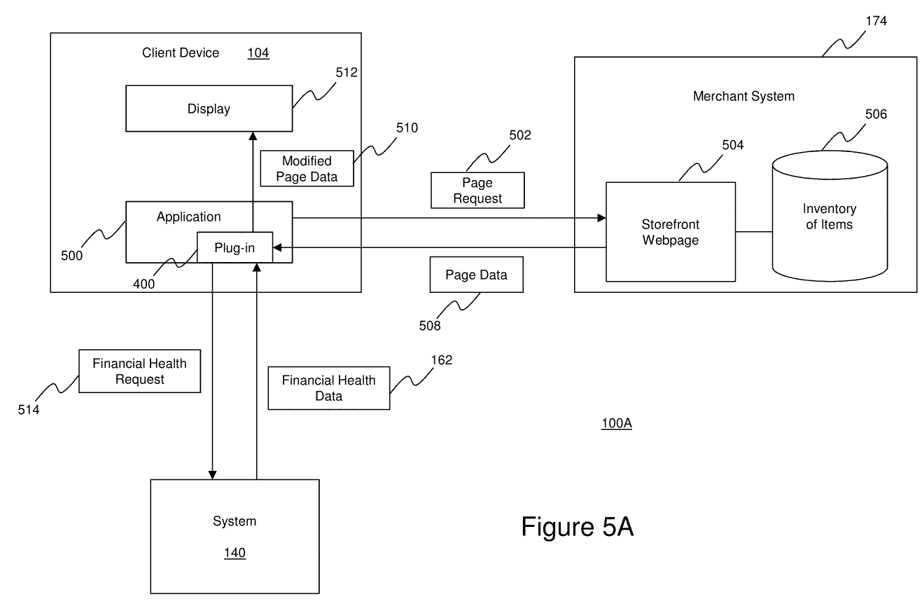

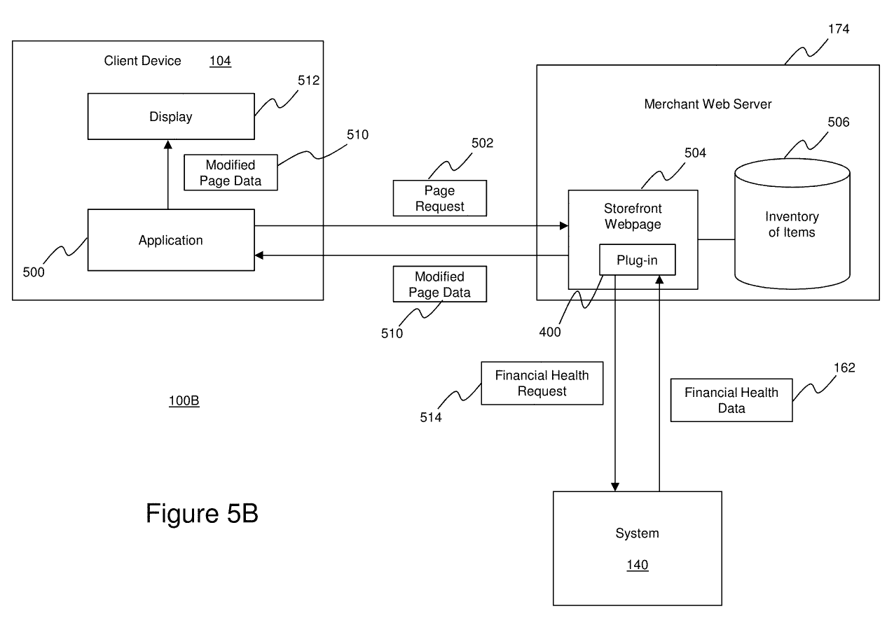

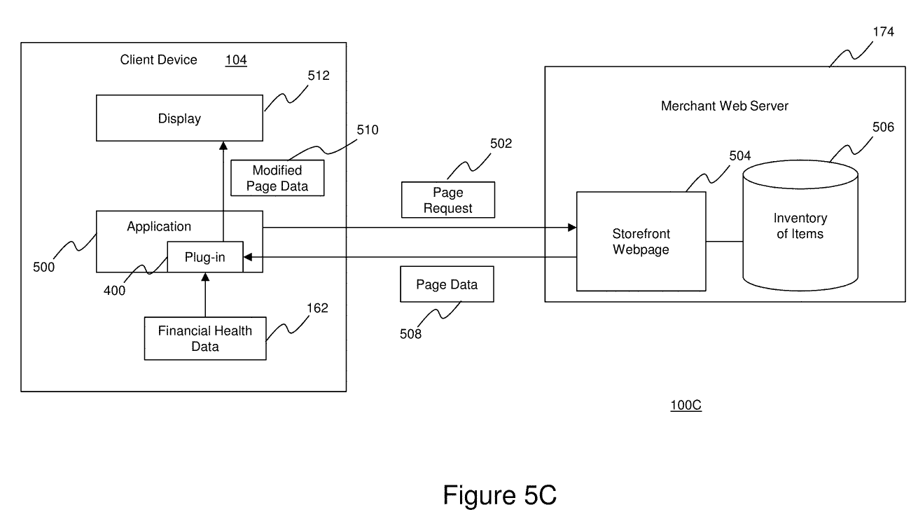

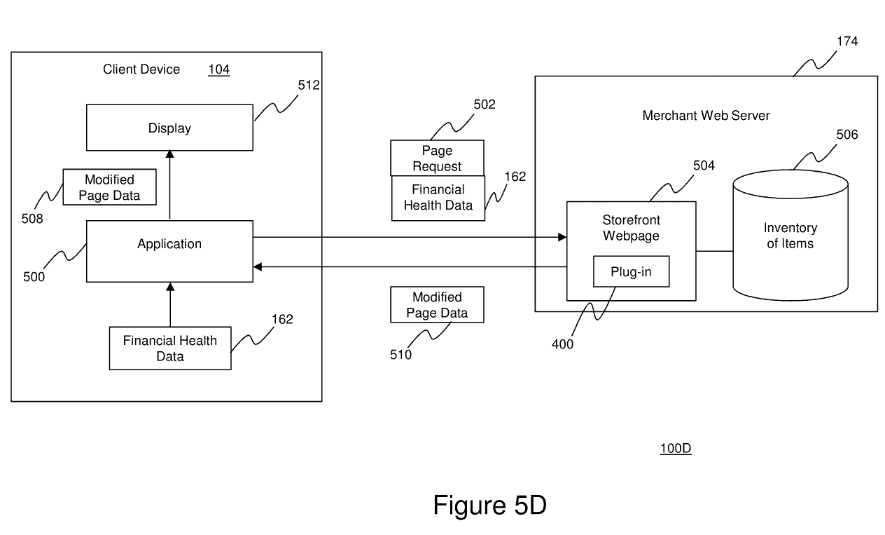

FIG. 3 illustrates an example computer system 300. Computer system 300 may reflect computer systems and computing devices associated with system 140, mobile application server 142, web server 148, data server 160, cryptographic server 170, merchant system 174, and client device 104. As such, the processes and operations described herein may be operable on or adapted to be operable on a computer system 300 located at and used by/for any of the entities shown in FIG. 1 (see also FIGS. 5A-5D described below).

In certain example embodiments, computer system 300 may include one or more processors 302 coupled to a communications module 304, a memory device 306, an input device 310 and one or more sensors 320. Communications module 304 enables the computer system 300 to communicate with one or more other components of computing environment 100, such as client device 104 or system 140 (or one of its components), via a bus or other communication network, such as communication network 120. Memory device 306 can include tangible and non-transitory computer-readable medium having stored therein computer programs, sets of instructions, code, or data to be executed by processor 302. Input device 310 provides a mechanism for a user of the computer system 300 to provide inputs to the computer system 300, such as during the execution of computer programs stored in memory device 306. Input device 310 can include a touch-sensitive display 312, keyboard, keypad, mouse, microphone, or other device capable of receiving or detecting an input. The computer system 300 may also include one or more sensors 320 coupled to processor 302, such as an accelerometer 322, magnetometer 324 and gyroscope 326. The sensors 320 can be used to determine an orientation and/or movement of the computer system 300 (e.g., client device 104 in the form of a smartphone).

The touch-sensitive display 312 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. In certain example embodiments, the touch-sensitive display 312 is a capacitive touch-sensitive display which includes a controller 314, and a capacitive touch-sensitive overlay 316 over a display 318. The overlay 316 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as gestures, may be detected by the touch-sensitive display 312. A gesture may be detected from any suitable object, such as a finger, thumb, appendage, or other items, for example, a stylus, pen, or other pointer, depending on the nature of the touch-sensitive display 312. The location of the gesture moves as the detected object moves during a gesture. Changes in the capacitive touch-sensitive overlay 316 are provided to a controller 314 when a gesture is received. The controller 314 and/or the processor 302 process the changes in the capacitive touch-sensitive overlay 316 to detect a touch by any suitable contact member on the touch-sensitive display 312. The processor 302 may determine attributes of the gesture, including a location of a touch. Touch location data may include an area of contact or a single point of contact, such as a point at or near a center of the area of contact, known as the centroid. Similarly, multiple simultaneous touches can be detected (referred to as multi-touch gestures)

If the gesture spans more than one location of the touch-sensitive display 312, the gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture.

Example gestures include a tap, a swipe, a pinch, and multi-touch variations thereof (e.g., more than one tap simultaneously at different locations of the touch-screen display 312). Gestures can also have a specific pattern or path on the touch-screen display 312, having different directions at different parts of the gesture. The touch-sensitive overlay 316 may evaluate gestures at certain intervals or points along its path rather than using each of location or point of contact over the duration of the gesture to resolve a direction or other attributes.

In some examples, the touch-sensitive display 312 may include one or more force sensors 330 disposed in any suitable location to detect a force imparted by a gesture on the touch-sensitive display 312. The force sensor 330 may include a force-sensitive resistor, strain gauge, piezoelectric or piezoresistive device, pressure sensor, or other suitable device or technology used to measure force. Force as utilized throughout the specification refers to force measurements, estimates, and/or calculations, such as pressure, deformation, stress, strain, force density, force-area relationships, thrust, torque, and other effects that include force or related quantities.

Force information related to a detected gesture may be utilized to select information, such as information associated with a location of a gesture. For example, a gesture that does not meet a force threshold may highlight a selection option, whereas a gesture that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming. In certain example embodiments, the magnitude of force of a gesture may be used to infer a state of the user providing the gesture (e.g., a stronger force can indicate an urgency of the user in causing the computer system 300 to perform the function associated with the gesture.

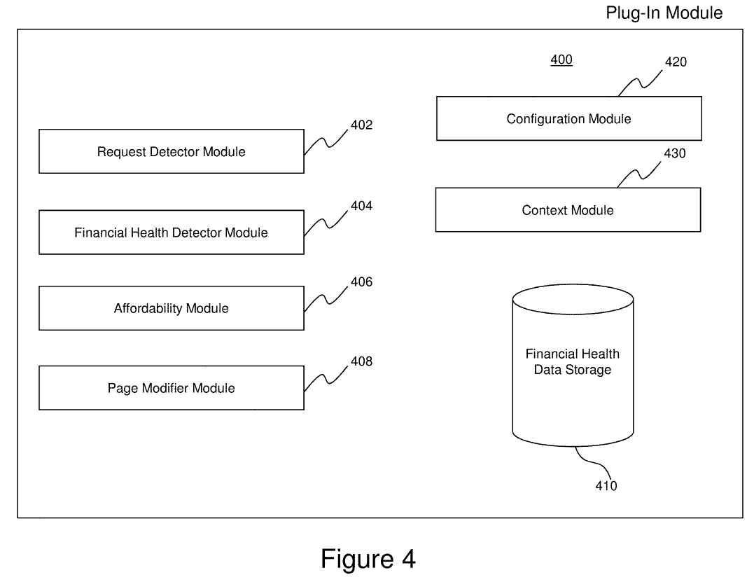

In FIG. 4, an example configuration of a plug-in module 400 is shown. The plug-in module 400 may be a standalone application, which may in turn interact with another software application through a corresponding API, or be part of another software application stored in memory 306 as depicted in FIGS. 5A-5D described below. In certain example embodiments, plug-in module 400 is part of a mobile application stored on client device 104 used to make payments to purchase products and services. For example, the plug-in module 400 may be part of a web browser, merchant-specific application (“app”) or any other application or online portal that includes at least some form of viewing and purchasing capabilities. In other example embodiments, the plug-in module 400 may be part of software installed on other types of computer systems 300, such as a kiosk or other terminal providing or otherwise having Internet access.

The term “plug-in” is used herein for ease of reference in certain example embodiments, for example, to represent code that is embedded in a web browser or existing application in order to provide the screen interruption and page modification capabilities described herein in order to control the display of a subset of items that would normally be displayed in association with products or services available for purchase. However, in other example embodiments, the plug-in module 400 can be embodied as any computer application, program, widget, software module, script, software add-on or otherwise computer executable code or instructions that can be executed by an application using a processor in order to determine affordability of a subset of items relative to financial health of a purchasing entity, and modify what is displayed for the requestor initiator.

Plug-in module 400 may include as shown in FIG. 5, a request detector module 402, a financial health detector module 404, an affordability module 406, and a page modifier module 408.

Request detector module 402 receives an input from an input device 310 representing a request by a request initiator to view items within a webpage or application in which an ability to purchase is provided or otherwise at least has an affordability associated therewith (e.g., for subsequent purchase through other channels). In certain example embodiments, the request detector module 402 monitors the activities performed by client device 104 to identify when a request to display such items is being made by client device 104. For example, the request detector module 402 can monitor the activity of other applications running on client device 104 (e.g., use of digital wallet application to make a payment, internet browser for online purchasing activity, etc.).

Financial health detector module 404 obtains financial health data 162 associated with the request initiator. In certain example embodiments, financial health detector module 404 can request and receive financial health data 162 from data server 160 via the network 120 through a corresponding API.

In certain example embodiments, financial health detector module 404 can generate financial health data 162 from customer data 200, account data 202 and/or transaction data 204 by accessing data storage 152 across network 120 through a corresponding API and store such data in financial health data storage 410. In other example embodiments, the financial health detector module 162 can obtain financial health data 162 from the device 104 itself as shown in FIGS. 5C and 5D described later.

Affordability module 406 compares financial health data 162 with data and parameters associated with items to be displayed in response to web browser or application queries. The data and parameters associated with such items may include cost, payment schedules or payment plans, payment options (e.g., debit versus credit), amount of item per unit cost, etc. The affordability module 406 performs such comparisons in order to determine affordability of items based on the financial health data 162 and any thresholds or criteria associated therewith. For example, the financial health data 162 may set certain cost upper limits based on the type of item and how that item fits into a budget or monthly spending allowance.

Page modifier module 408 coordinates with the affordability module 406 to determine which of the items to be displayed may be determined unaffordable and therefore should be identified as one of a subset of those items that is to be obfuscated or eliminated from what is displayed. As described herein, the items may have media content associated therewith that can be modified or eliminated by the page modifier module 408 in order to affect how or whether the subset of items is displayed.

In certain example embodiments, plug-in module 400 may include a configuration module 420 and a context module 430. The configuration module 420 can provide settings to control various operations of plug-in module 400. For example, configuration module 420 may provide settings regarding the types of requests received by the request detector module 402 that trigger further execution of the plug-in module 400. In certain example embodiments, the plug-in module 400 can be configured to only determine an additional input for requesting display of certain items when certain criteria are met (e.g., when requested item costs less than a certain threshold, etc.). The configuration module 420 may also provide settings for: specifying the source(s) from which to retrieve financial health data 162, the types of financial health data 162 or criteria (e.g., threshold values) to use for evaluating financial health, etc. In certain example embodiments, the configuration module 420 displays a corresponding graphical user interface (e.g., on touch-sensitive display 312) to enable a user 110 of the client device 104 to set the configuration settings. In certain example embodiments, the configuration settings may be set by business entity 190.

The context module 430 receives or determines context data associated with a session in which the merchant system 174 is being accessed. The context data for a session can include numerous information related to a transaction or operation, such as information on the product or service being searched and/or browsed, the location where the session is taking place, whether similar or related purchases or transactions have been completed in the past, other metadata, etc.

In certain example embodiments, the context module 430 may request and receive context data from other applications running on client device 104, or from other computer systems and servers across network 120 through corresponding APIs.

In certain example embodiments, the context module 430 analyzes the context data to determine a priority indicator of the session and such priority indicator can be used by the input determination module 406 to adjust the level of obfuscation or thresholds used to determine whether or not to obfuscate or eliminate the media content associated with particular items that would otherwise be displayed.

It will be appreciated that plug-in module 400 may be incorporated into a single computer or a single server or service, or alternatively, may be distributed among one or more computing systems 300. In certain example embodiments, plug-in module 400 (or a module thereof as shown in FIG. 4) may be implemented as one or more software programs, such as a software application (e.g., a web service or mobile application) executed by one or more processors included in one of the other servers of system 140, client device 104, or another server or computer system 300.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers in system 140 or client device 104, or accessible or connectable thereto. Any application or module herein described may be implemented using computer readable/executable instructions that may be stored or otherwise held by such computer readable media.

The removal and/or reduction of visibility (e.g., obfuscation) of items being displayed, based on the item's affordability relative to a financial health of a user, can be performed in various configurations. FIGS. 5A-5D provide example embodiments in which the plug-in module 400 can be incorporated into respective computing environments 100A-100D. It can be appreciated that some modules and components from the client device 104, merchant system 174 and system 140 are omitted from FIGS. 5A-5D for ease of illustration.

In FIG. 5A, the plug-in module 400 is embedded or otherwise included in or accessible to an application 500 on the client device 104, e.g., a web browser application or app stored in memory 306. That is, the plug-in module 400 can be embodied as, for example, a browser plug-in that adds the functionality of the plug-in module 400 as herein described to an existing web browser. Similarly, the plug-in module 400 can be embodied as any software component that is embedded or accessible to any application 500 that is capable of accessing the merchant system 174 and of displaying items that are determined to be affordable to a purchasing entity.

The plug-in module 400 in this example embodiment is configured to be in communication with a storefront webpage 504, e.g., by accessing a communications module 304 of the client device 104. In this way, after the application 500 generates and sends a page request 502 to a storefront webpage 504 to access and display content therefrom, the plug-in module 400 can receive page data 508 generated and returned by the storefront webpage 504 via the communication network 102. The content associated with the items to be displayed may include items that have a cost or other metric associated therewith that affects the item's affordability to a purchasing entity. The plug-in module 400 may obtain the page data 508 from the application 500 or may obtain the page data 508 by intercepting the page data 508 by, for example, listening for the reply to the request 502 via the communications module 304. The storefront webpage 504 in this example embodiment may represent a web server or web page that has been programmed to display items associated with products and/or services and in at least some embodiments provide an ability to purchase those products and services via the storefront webpage 504 or by linking to a payment portal.

The merchant system 174 in this example includes or otherwise has access to an inventory of items 506 having data associated with and representative of each item, for example, photos, video, text, hyperlinks, etc. The page data 508 received by the plug-in module 400 from the storefront webpage 504 may include data representative of at least one item from the inventory of items 506, and this data can be displayed by the plug-in module 400 or application 500 itself on an electronic display 512 of or coupled to the client device 104. For example, the client device 104 may be a smart phone, tablet or laptop computer or desktop computer that is being used to browse an e-commerce website wherein the plug-in module 400 detects that the purchasing entity operating the client device 104 has entered such a website. The plug-in module 400 may then operates as described herein to eliminate/remove/block or obfuscate a subset of items based on affordability relative to financial health data 162 associated with that purchasing entity.

As indicated above, the affordability of an item relative to financial health data 162 can be determined in accordance with various metrics and parameters. Affordability may be determined according to thresholds established based on item-cost limits, a budget or budget category, etc. For example, if a user has a budgeting parameter that stipulates a clothing budget of $1,000 per year, a cost threshold to determine affordability can be set at $100 for any one item. The budgeting parameters and cost thresholds can also have more or less granularity. For example, within a clothing category, a budget for shoes may be established with a cost threshold for that specific type of item being set such that any items associated with shoes that are at or above that threshold are eliminated or obfuscated on the display 512 by modifying the page data 508 to generate modified page data 510. This enables the plug-in module 400 to control access to particularly expensive brands for certain types of items, either as imposed by the user or the business entity 190.

The metrics for establishing affordability and modifying page data 508 accordingly can be done for various purposes and can be enforced by the user or the business entity 190 as noted above. For example, affordability and cost thresholds can be enforced for meeting a budget or a savings goal. Affordability and cost thresholds can also be enforced based on account credit-payment history such as when it is detected that a user is only making minimum payments on a credit card, based on the availability of cash or credit, based on seasonal income and employment, etc. These metrics may also be adjustable and/or self-adjusting as financial health data 162 indicates an improvement in financial health in any one of these categories. The determination of affordability can be included in the financial health data 162 by the system 140, or can be determined at the client device 104 by the plug-in module 400 by comparing cost or other item-related data to financial health and any cost thresholds established to enable affordability to be measured and enforced.

In some example embodiments, the financial health data 162 may be requested periodically by the plug-in module 400 by sending a financial health request 514 to the system 140. In this way, the financial health data 162 can be stored at the client device 104 and made available to the plug-in module 400 whenever e-commerce activity as herein described is detected. In other example embodiments, the financial health data 162 may be requested each time a page request 502 or particular type of page request 502 (e.g., e-commerce related) is made, such that fresh financial health data 162 is obtained as desired.

The modified page data 510 may be generated in various ways. In certain example embodiments, items may be completely removed from what is displayed by removing the corresponding item data from the page data 508 received from the storefront webpage 504. For a web-browser that utilizes HTML, the HTML code tags can be intercepted by the plug-in module 400 and the portions of code associated with the subset of items that are not determined to be affordable can be eliminated during the rendering of the HTML code on the browser. In other embodiments, items may also be obfuscated or otherwise made less available on the display, for example, by applying transparency or opaqueness to the media content used to display the item. In one example, the HTML code is modified to incorporate this transparency or opaqueness, or an overlay can be generated that visually obfuscates the underlying media content for the item. An ability to purchase the underlying item can also be removed, for example, by removing links or selectable options that direct a purchasing entity to a shopping cart and/or payment portal. The amount or degree of transparency or opaqueness can be varied based on the affordability of the item itself, the state of the financial health of the purchasing entity, or both. It can be appreciated that both elimination of items and obfuscation of items may be applied. For example, items that are extremely unaffordable can be eliminated from the display 512 while other items that are less unaffordable can have their visibility reduced by including transparency or opaqueness, in varying degrees.

In certain example embodiments, the plug-in module 400 may be operable at the merchant web server 174 as illustrated in FIG. 5B. In the example embodiment shown in FIG. 5B, the plug-in module 400 may be embedded in or accessible to the storefront webpage 504 such that the modified page data 510 is generated and sent to certain client devices 104 based on financial health of the associated purchasing entity. The financial health data 162 may be received by the merchant web server 174 from the system 140 in response to a financial health request 514 sent by the plug-in module 400 to the system 140 from the merchant web server 174. In this way, the control of what is displayed on the display 512 of the client device 104 can be implemented at the server side such that the client device 104 is either unaware or otherwise not responsible for how or when the page data 508 is modified. The deployment of the plug-in module 400 at the merchant web server 174 may be implemented by way of agreements or partnerships between certain merchant entities and the business entity 190, e.g., to provide a budgetary or savings program or campaign. The deployment of the plug-in module 400 at the merchant web server 174 may also be implemented in order to offload processing and communication requirements for the client device 104, e.g., to minimize the data being sent and received to/from the client device 104.

In certain example embodiments, the plug-in module 400 may be operable at the client device 104, similar to FIG. 5A, but may obtain financial health data 162 at the client device 104 as shown in FIG. 5C. In the example embodiment shown in FIG. 5C, the page requests 502 are sent to the merchant web server 174, and page data 508 is received from the merchant web server 174, while the financial health data 162 is available on the client device 104 without requiring a separate communication by the client device 104 with the system 140. When financial health data 162 can be determined from the client device's activities or from application data available or generated on the client device 104, the plug-in module 400 can generate the modified page data 510 without requiring access to the system 140. For example, the application 500 may be in communication with another application such as a mobile wallet application (not shown) that is associated with the business entity 190 and therefore already has an ability to receive and store or be made aware of the financial health data 162. In other certain example embodiments, the implementation depicted in FIG. 5C may represent a scenario wherein the financial health data 162 is received periodically from the system 140 or from another third party service and stored by the client device 104 for subsequent use.

FIG. 5D illustrates another example embodiment wherein the financial health data 162 is stored on the client device 104 and is sent by application 500 to a plug-in module 400 on the merchant web server 174. The financial health data 162 may be appended or included in the page request 502 as shown in FIG. 5D to enable the storefront webpage 504 to utilize the plug-in module 400 to generate the modified page data 510. For example, the financial health data 162 may be included in a data packet used to send the page request 502.

It can be appreciated from FIGS. 5A-5D that various implementations are possible for incorporating the plug-in module 400 or equivalent functionality into a computing system 100 to generate and display modified page data 510 according to the principles discussed herein. The operations performed by the plug-in module 400 may be adapted to the computing device 300 on which the plug-in module 400 is deployed. For example, generating an output for the display 512 when performed at the storefront webpage 504 may include preparing data suitable to be displayed by a recipient application 500 whereas a similar output generated by the plug-in module 400 on the client device 104 may include the displaying operation itself.

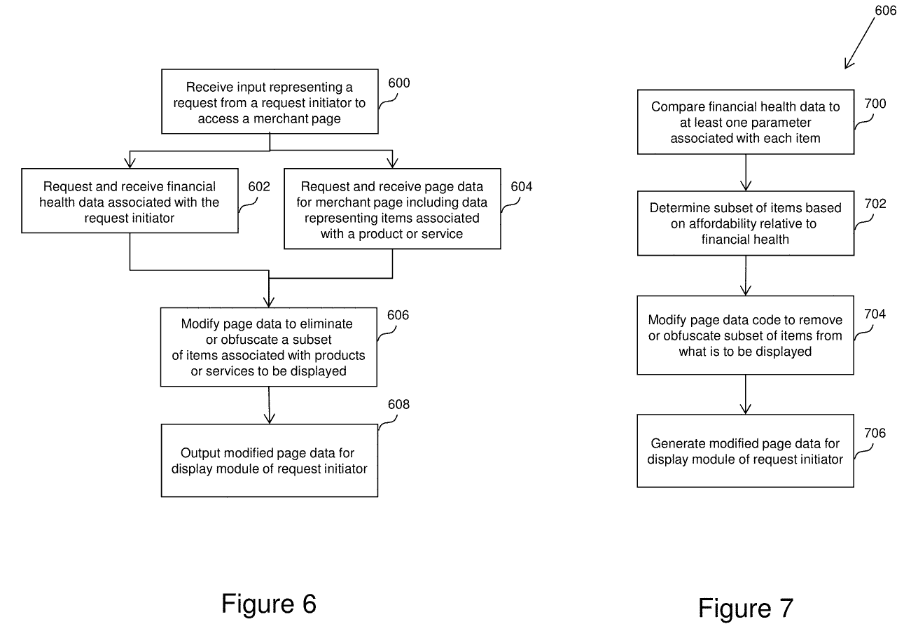

Referring to FIG. 6, an example embodiment of computer executable instructions executable by the plug-in module 400 for displaying content on a display is shown. At block 600, the request detector module 402 receives an input from an input device 310 representing a request from a request initiator to access a web page or application page that is associated with e-commerce, includes an ability to make or initiate a purchase, or otherwise includes media content for items that could be purchased through another channel. For example, the first input can be the submission by user 110 of a search query or selection of an e-commerce website or application. In another example, the first input can be initiated by an application 500 on the client device 104 such as a social media update or message that includes content with items having a determinable affordability.

At block 602, financial health detector module 404 requests and receives financial health data 162 associated with the request initiator via the communication module 304. In certain example embodiments, client device 104 requests financial health data 162 associated with the user 110 across network 120 from data server 160. Data server 160 retrieves financial health data 162 associated with user 110 and sends such data across network 120 to client device 104. In certain example embodiments, block 602 may be performed during a separate process such as during a periodic financial health update that is independent of the input received in block 600. For the present example embodiment illustrated in FIG. 6, block 602 may be performed after receiving such an input at block 600.

At block 604, a page request 502 is generated responsive to the input received at block 600. Page data 508 is also received at block 604 in this example embodiment, the page data 508 includes data (e.g., media content) representing items associated with a product or service as herein described. As illustrated in FIG. 6, the requesting and receiving of page data 508 may be performed at least in part in parallel with requesting and receiving financial health data 162 in block 602. Requesting and receiving page data 508 may occur immediately upon receiving the input at block 600 or the user may experience a delay, for example, to account for the financial health data 162 being received and processed when there is latency in the process.

At block 606, the received page data 508 is modified to generate the modified page data 510 in which media content and/or other data associated with a subset of items is affected to minimize or eliminate an ability to purchase a product or service associated with the subset of items. For example, certain items may be removed from the page data 508 such that those items are not displayed, or may be obfuscated, or a combination of the two techniques for a plurality of items that are affected.

At block 608 the modified page data 510 is output to be displayed by the display 512 on the client device 104. As indicated above, the modified page data 510 in some example embodiments is generated by the plug-in module 400 residing at the client device 104 but the plug-in module 400 may also reside on the web merchant web server 174 in which case block 608 would include transmitting the modified web page data 510 to the application 500 requesting the page data 510.

The items being modified from the page data 508 may be modified in various ways in order to reduce or eliminate access to and/or awareness of the subset of items based on the affordability of those items relative to the financial health data received at block 602. Referring to FIG. 7, an example embodiment of computer executable instructions executable by the plug-in module 400 for generating modified page data 510 to be displayed is shown. At block 700, the affordability module 406 of the plug-in module 400 may be used to compare the financial health data 162 to at least one parameter associated with each item such as the cost of the product or service, the type or category of item, frequency of purchase of that item, and/or other contextual information determined by the context module 430. Comparing the financial health data 162 to a parameter such as a cost associated with the item enables the affordability module 406 to determine how affordable, if at all, that item is relative to the financial health data 162. The financial health data 162 may include thresholds associated with overall purchases or individual items. For example, a cost threshold of $100 may be appropriate for certain types of clothing but considered high for items like office supplies.

In certain example embodiments, the financial health data 162 may include a debt-to-income ratio used to evaluate the financial health of user 110. If the financial health data 162 indicates an ACCEPTABLE financial health (i.e., debt-to-income ratio equal to a predetermined ratio threshold associated with acceptable financial health), the cost threshold can be relatively higher than less acceptable financial health. If the financial health data 162 indicates WEAK financial health (i.e., debt-to-income ratio is above the predetermined ratio threshold associated with acceptable financial health), the cost threshold can be relatively lower. The cost of the item relative to these cost thresholds can also be used to determine a degree of affordability. That is, when an item is deemed to be less than affordable, the difference between the item's cost and the cost threshold can be used to vary a degree of obfuscation and/or to determine whether or not the item should be eliminated from the displayed output. If the financial health data 162 indicates STRONG financial health (i.e., debt-to-income ratio is below the predetermined ratio threshold associated with acceptable financial health), that item may be left alone to be displayed in the usual manner.

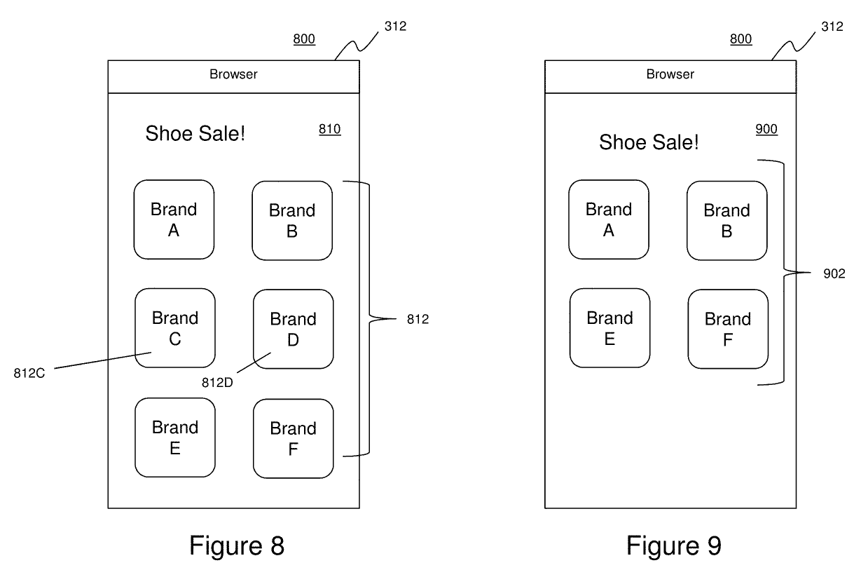

FIGS. 8 to 11 illustrate an example graphical user interface 800 of a browser application 500 displayed on the touch-sensitive display 312 of client device 104. The touch-sensitive display 312 displays a screen 810 listing a number of shoe brands associated with a shoe sale. Each brand in this example can be considered an item as herein described, with the screen 810 displaying a set of items each having content 812 rendered on the display 512. In FIG. 8, it can be assumed that the plug-in module 400 is not currently being used or has determined that all of the set of items is affordable and thus all corresponding content 812 can be displayed.

FIG. 9 is an example embodiment illustrating the elimination/removal/blocking of first content 812C associated with Brand C and second content 812D associated with Brand D. Content 812C, 812D is not displayed with the filtered content 902 shown in FIG. 9 based on affordability of the corresponding items relative to the financial health data 162 for the purchasing entity. For example, Brand C may have a cost of $500 and Brand D have a cost of $800 while the user has a relatively WEAK financial health. A cost threshold of $100 may be set for this level of financial health, in which case Brands C and D are much higher than the threshold and are eliminated from the screen 900 that is rendered on the display 512.

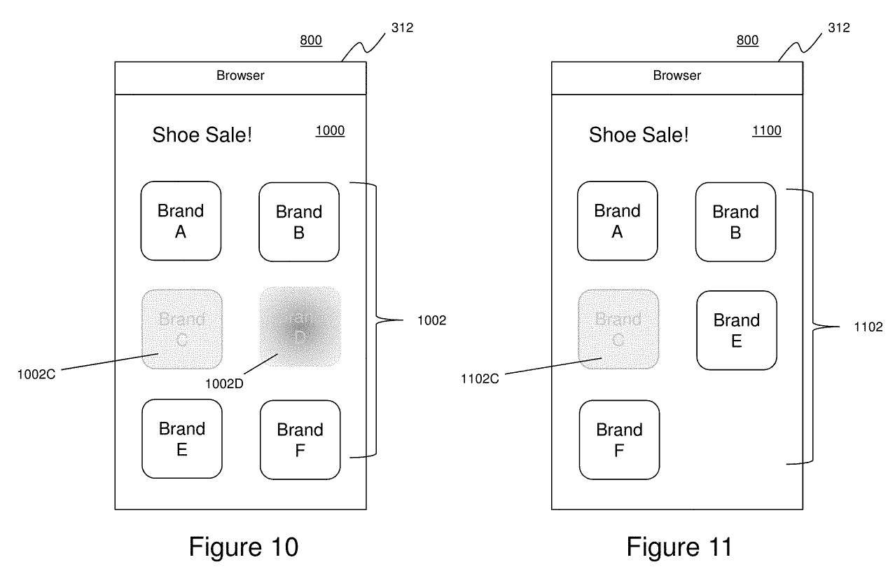

FIG. 10 is an example embodiment illustrating the obfuscation of content 812C and 812D when rendering a screen 1000 displaying content 1002. Brands C and D in this example may be considered less than affordable but more affordable than in the example shown in FIG. 9. The obfuscation applied in this example embodiment provides an overlay with opaqueness that varies based on the affordability of the particular item, relative to the financial health data 162. A similar effect can be provided by blurring the existing media content. For example, if the financial health data is ACCEPTABLE, the cost threshold for shoes may be set at $400. In this scenario, Brand C is closer to meeting that threshold than Brand D and therefore Brand D is obfuscated to a higher degree. It can be appreciated that the obfuscation may disable an ability to select the content 1002C, 1002D, may only obscure the content 1002C, 1002D to indicate relative unaffordability, may require additional operations to be able to make a subsequent purchase, or any combination of these techniques. The varying obfuscation can also be applied according to other parameters such as method of payment. For example, Brand C may be payable by a credit card type that the user has, while Brand D can only be purchased using a debit card, whereby immediate access to funds may be an issue with respect to the financial health of the user.

FIG. 11 illustrates an example embodiment in which both obfuscation and removal of items is applied, when compared to the set of content 812 shown in FIG. 8. In the scenario depicted in FIG. 11, content 1102C for Brand C is obfuscated while content 812D is eliminated for Brand D based on the corresponding costs for those items relative to the cost threshold. That is, a combination of obfuscation of content to be displayed, with varying levels; and removal or elimination of content can be applied according to the comparisons made between cost of the item, the financial health of the purchasing entity and the determined relative affordability.

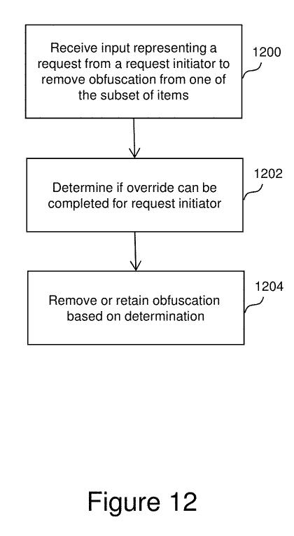

The obfuscated content, for example, content 1002C, 1002D for Brands C and D may be overridden by the user, in order to purchase the corresponding items, despite the affordability warnings for those items. The ability to override the obfuscation may be controllable by way of user preferences in the configuration module 420 or may be controllable by the business entity 190 in generating the financial health data 162. For example, the financial health data 162 may include an additional category that enables the obfuscation to be overridden based on the level of financial health or relative affordability. FIG. 12 an example embodiment of computer executable instructions executable by the plug-in module 400 for enabling the obfuscation to be overridden is shown.

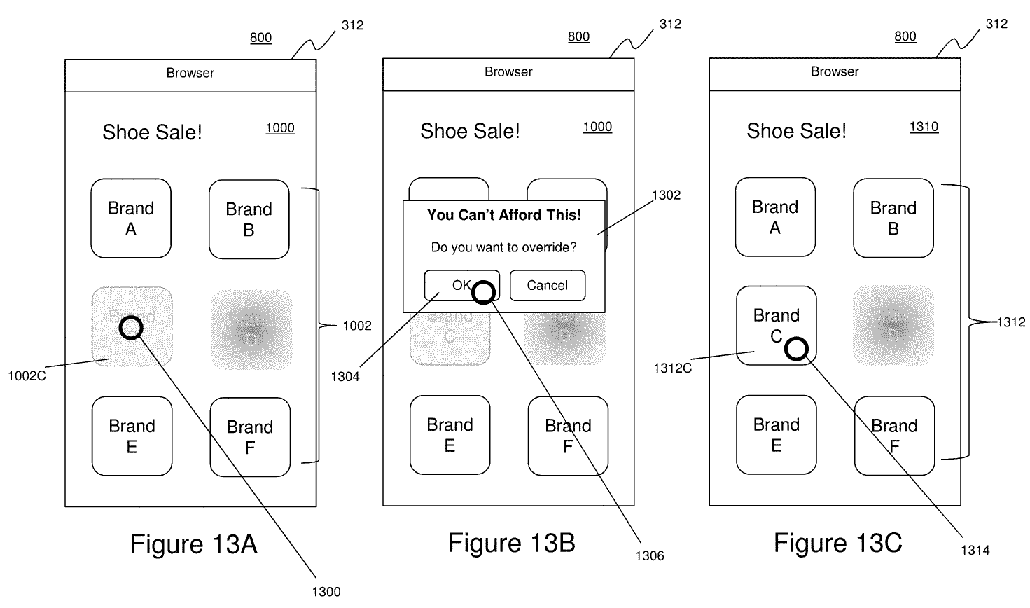

At block 1200 the plug-in module 400 receives an input representing a request from a request initiator to remove an obfuscation from one of the subset of items that is displayed with such obfuscation. In an example embodiment shown in FIG. 13A, the input corresponds to a tap or press input 1300 applied to the content 1002C.

At block 1202 the plug-in module 400 may determine if the requested override can be completed for the request initiator. For example, an ability to override can vary based on the amount of obfuscation which is in turn based on the relative affordability of the item. The determination in block 1202 may also include a warning, prompt or other additional interaction(s) that make it more difficult to complete the purchase of the associated item. In an example embodiment shown in FIG. 13B, after applying the input 1300 an override prompt 1302 may be displayed which includes a textual warning and requires confirmation that the user still wishes to proceed with the override. In this example embodiment, applying an additional input 1306 such as a tap or press to an OK button 1304 can provide such a confirmation.

At block 1204 the plug-in module 400 may remove or retain the obfuscation or otherwise further control access to the content associated with the item based on the determination in block 1202. In an example embodiment shown in FIG. 13C, the obfuscation applied to item 1312C is removed such that Brand C becomes available for further viewing and/or purchase when rendering screen 1310.

Accordingly, it can be appreciated that avoiding or limiting access to items displayed on an electronic device, which are associated with products and services that are determined to be unaffordable to a consumer or other purchasing entity relative to financial health data; may deter or minimize the desire to purchase those products or services. When a purchasing entity is deterred or prevented from accessing and purchasing certain items, or is unaware of the availability of such items altogether, obstacles to maintaining a budget or accumulating savings may be avoided. Additionally, the ability to override obfuscation can provide a level of information to the purchasing entity regarding affordability while not completely restricting purchases.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific examples, various modifications thereof will be apparent to those skilled in the art as outlined in the appended claims.

1. A computing device for displaying content on an electronic display, the device comprising a processor coupled to a memory, a communications module, and the electronic display, the memory storing computer executable instructions that when executed by the processor cause the processor to:
receive via the communications module data representing a plurality of items, each of the plurality of items being associated with at least one of a product and service;
request and receive via the communications module financial health data associated with a purchasing entity;
determine a subset of items from the plurality of items based on affordability relative to the financial health data; and
display at least one of the plurality of items on the electronic display.

2. The device of claim 1, wherein the computer executable instructions further cause the processor to display the subset of items in a different manner than the other plurality of items displayed.

3. The device of claim 2, wherein visibility of the subset of items is reduced.

4. The device of claim 3, wherein the visibility of each of the subset of items is reduced respectively based on the affordability to the purchasing entity.

5. The device of claim 1, wherein the subset of items is excluded from being displayed.

6. The device of claim 1, wherein the financial health data comprises a budgeting parameter, and the affordability is based on exceeding the budgeting parameter by the purchasing entity obtaining the associated product or service.

7. The device of claim 1, wherein the computer executable instructions further cause the processor to obtain purchasing entity preference data, and each of the subset of items is associated with a product or service preferred by the purchasing entity based on the purchasing entity preference data.

8. The device of claim 3, wherein the computer executable instructions further cause the processor to provide an option to override an obfuscation of at least one of the subset of items.

9. The device of claim 1, wherein the computer executable instructions further cause the processor to:
receive an input from an input device of the computing device requesting access to a merchant page;
receive data associated with the plurality of items from a merchant system at the communications module over a communication network, responsive to the request;
compare at least one parameter associated with each item to the financial health data to determine whether or not the respective item is affordable in determining the subset of items;
modify the data representing the plurality of items to reduce or eliminate access to the subset of items when displaying the at least one of the plurality of items on the electronic display; and
send the modified data to the electronic display for an application on the computing device that provides access to the merchant system.

10. A method of displaying content on an electronic display, comprising:
receiving data representing a plurality of items, each of the plurality of items being associated with at least one of a product and service;
requesting and receiving financial health data associated with a purchasing entity;
determining a subset of items from the plurality of items based on affordability relative to the financial health data; and
displaying at least one of the plurality of items on the electronic display.

11. The method of claim 10, wherein the subset of items is displayed in a different manner than the other plurality of items displayed.

12. The method of claim 11, wherein visibility of the subset of items is reduced.

13. The method of claim 12, wherein the visibility of each of the subset of items is reduced respectively based on the affordability to the purchasing entity.

14. The method of claim 10, wherein the subset of items is excluded from being displayed.

15. The method of claim 10, wherein the financial health data comprises a budgeting parameter, and the affordability is based on exceeding the budgeting parameter by the purchasing entity obtaining the associated product or service.

16. The method of claim 10, further comprising obtaining purchasing entity preference data, each of the subset of items being associated with a product or service preferred by the purchasing entity based on the purchasing entity preference data.

17. The method of claim 12, further comprising providing an option to override an obfuscation of at least one of the subset of items.

18. The method of claim 10, further comprising:
receiving an input from an input device of the computing device requesting access to a merchant page;
receiving data associated with the plurality of items from a merchant system at the communications module over a communication network, responsive to the request;
comparing at least one parameter associated with each item to the financial health data to determine whether or not the respective item is affordable in determining the subset of items;
modifying the data representing the plurality of items to reduce or eliminate access to the subset of items when displaying the at least one of the plurality of items on the electronic display; and
sending the modified data to the electronic display for an application on the computing device that provides access to the merchant system.

19. A non-transitory computer readable medium for displaying content on an electronic display, the computer readable medium comprising computer executable instructions for:
receiving data representing a plurality of items, each of the plurality of items being associated with at least one of a product and service;
requesting and receiving financial health data associated with a purchasing entity;
determining a subset of items from the plurality of items based on affordability relative to the financial health data; and
displaying at least one of the plurality of items on the electronic display.

20. The non-transitory computer readable medium of claim 19, wherein the computer executable instructions further cause the processor to display the subset of items in a different manner than the other plurality of items displayed, the different manner comprising at least one of reducing visibility of the subset of items, and excluding the subset of items from being displayed.
